(19) United States
(12) Patent Application Publication
(10) Pub. No.: US 2025/0390717 A1
(43) Pub. Date: Dec. 25, 2025

(54) INFERENCE PROCESSING DEVICE, INFERENCE PROCESSING METHOD AND INFERENCE PROCESSING PROGRAM

(71) Applicant: NIPPON TELEGRAPH AND TELEPHONE CORPORATION, Tokyo (JP)

(72) Inventors: Yuya OMORI, Tokyo (JP); Shuhei YOSHIDA, Tokyo (JP); Ken NAKAMURA, Tokyo (JP); Daisuke KOBAYASHI, Tokyo (JP); Saki HATTA, Tokyo (JP); Hiroyuki UZAWA, Tokyo (JP); Yuko IINUMA, Tokyo (JP)

(73) Assignee: NIPPON TELEGRAPH AND TELEPHONE CORPORATION, Tokyo (JP)

(21) Appl. No.: 18/881,279

(22) PCT Filed: Jul. 15, 2022
(86) PCT No.: PCT/JP2022/027940

§ 371 Date: Jan. 4, 2025

(51) Int. Cl. G06N 3/0464; G06N 5/04

(52) U.S. Cl. CPC G06N 3/0464; G06N 5/04

(57) ABSTRACT

An inference processing device includes: a division unit that divides a layer of a convolutional neural network into a plurality of sublayers in a channel direction; a convolution unit that executes convolution processing for each of the sublayers to output a convolution result; an addition unit that adds an intermediate value obtained by cumulatively adding convolution results up to a previous sublayer to the convolution result with an adder for adding a bias to the convolution result every time the convolution processing is executed, and outputs an addition result; and an activation unit that inputs, to an activation function, the addition result obtained by adding the convolution result of a last sublayer on which the convolution processing has been executed last.

### TECHNICAL FIELD

The disclosed technique relates to an inference processing device, an inference processing method, and an inference processing program that perform convolution processing in a neural network.

### BACKGROUND ART

In a convolutional neural network (CNN), a network model includes a plurality of layers, and convolution processing is performed in a convolutional layer. In the convolution processing, an input feature map output in a previous layer or the like and kernel data that is a weight coefficient are used as inputs. Then, in the convolution processing, a bias is added to the product-sum operation of the input feature map and the kernel data, and activation function processing is performed to acquire an output feature map as an output.

In a case where the CNN inference processing or the learning processing is performed, in a case where the data size of the kernel data of the network model is relatively large, all the kernel data cannot be loaded onto the memory of a calculator or dedicated hardware at a time. Therefore, the network model may be divided and processed. Specifically, by dividing the network model, the kernel data is divided, and each of the divided pieces of kernel data can be loaded onto the memory at a time.

For example, Non Patent Literature 1 discloses a technique in which a feature map of each layer is divided into two in a channel direction, and two pieces of hardware are operated in parallel to perform learning. The divided network model and kernel data may be processed in parallel by separate hardware, or may be processed in order by the same hardware. For example, in a case where the CNN inference processing is sequentially executed by the same hardware, when the network model is divided into n pieces in an input channel direction, only one of the n pieces of kernel data is stored in the memory, and the convolution processing is sequentially executed by the same hardware, the size of the kernel data that needs to be simultaneously stored in the memory can be 1/n as compared with a case where the network model is not divided.

Here, the hardware that executes the CNN inference processing often has a multi-stage memory configuration including a high-speed, expensive, and low-capacity memory and a low-speed, inexpensive, and large-capacity memory. For example, in the case of dedicated hardware, a high-speed, expensive, and low-capacity internal memory such as static random access memory (SRAM) is often included inside a large scale integration (LSI) or the like. In addition, a low-speed, inexpensive, and large-capacity external memory such as dynamic random access memory (DRAM) is often included outside an LSI or the like. In this case, the size of the internal memory can be reduced by storing all the kernel data in the external memory and appropriately reading only the kernel data of 1/n size required in the current processing from the external memory into the internal memory.

### CITATION LIST

### Non Patent Literature

Non Patent Literature 1: Krizhevsky, Alex; Sutskever, Ilya; Hinton, Geoffrey E. (2017 May 24). “ImageNet classification with deep convolutional neural networks”. Communications of the ACM 60 (6): 84-90. doi: 10.1145/3065386. ISSN 0001-0782.

### SUMMARY OF INVENTION

### Technical Problem

However, in a case where the network model is divided into a plurality of pieces by the input channels and the convolutional layer inference processing is sequentially performed by the same hardware, it is necessary to add an adder circuit for finally integrating the convolution results of the divided pieces. In addition, it is also necessary to apply the activation function to the convolution result obtained by adding all the input channels. In addition, since the addition processing is performed in the adder circuit after the convolution results of the divided pieces once stored in the external memory are finally read again, there is a possibility that the processing time increases.

The disclosed technique has been made in view of the above points, and an object is to provide an inference processing device, an inference processing method, and an inference processing program capable of performing convolution processing that can be generally supported while suppressing an increase in hardware resources and processing time.

### Solution to Problem

A first aspect of the present disclosure is an inference processing device including: a division unit that divides a layer of a convolutional neural network into a plurality of sublayers in a channel direction; a convolution unit that executes convolution processing for each of the sublayers to output a convolution result; an addition unit that adds an intermediate value obtained by cumulatively adding convolution results up to a previous sublayer to the convolution result with an adder for adding a bias to the convolution result every time the convolution processing is executed, and outputs an addition result; and an activation unit that inputs, to an activation function, the addition result obtained by adding the convolution result of a last sublayer on which the convolution processing has been executed last.

A second aspect of the present disclosure is an inference processing method including: dividing, by a division unit, a layer of a convolutional neural network into a plurality of sublayers in a channel direction; executing, by a convolution unit, convolution processing for each of the sublayers to output a convolution result; adding, by an addition unit, an intermediate value obtained by cumulatively adding convolution results up to a previous sublayer to the convolution result with an adder for adding a bias to the convolution result every time the convolution processing is executed, and outputting an addition result; and inputting, by an activation unit, to an activation function, the addition result obtained by adding the convolution result of a last sublayer on which the convolution processing has been executed last.

A third aspect of the present disclosure is an inference processing program, the inference processing program being a program for causing a computer to function as each unit of the inference processing device of the first aspect.

### Advantageous Effects of Invention

According to the disclosed technique, it is possible to perform convolution processing that can be generally supported while suppressing an increase in hardware resources and processing time.

### BRIEF DESCRIPTION OF DRAWINGS

FIG. 1 is a schematic diagram illustrating an example of a hardware configuration of an inference processing device according to an embodiment.

FIG. 2 is a block diagram illustrating an example of a functional configuration of the inference processing device according to the embodiment.

FIG. 3 is a schematic diagram illustrating an example of a flow of convolution processing executed on each sublayer in a case where one layer is divided into three sublayers according to the embodiment.

FIG. 4 is a schematic diagram illustrating an example of a flow of processing of adding a convolution result with a bias adder according to the embodiment.

FIG. 5 is a schematic diagram illustrating an example of a function for inputting an addition result according to the embodiment.

FIG. 6 is a schematic diagram illustrating an example of a flow of processing of adding an addition result with a bias adder according to the embodiment.

FIG. 7 is a schematic diagram for describing an example of bit precision according to the embodiment.

FIG. 8 is a schematic diagram illustrating an example of setting of an undivided layer according to the embodiment.

FIG. 9 is a schematic diagram illustrating an example of setting of a divided layer according to the embodiment.

FIG. 10 is a flowchart illustrating an example of inference processing in the inference processing device according to the embodiment.

FIG. 11 is a schematic diagram for illustrating an example of processing executed in conventional art in a case where data for 32 channels can be stored in an internal memory.

### DESCRIPTION OF EMBODIMENTS

Hereinafter, an example of an embodiment of the disclosed technique will be described with reference to the drawings. Note that, in the drawings, the same or equivalent components and portions are denoted by the same reference numerals. In addition, dimensional ratios in the drawings are exaggerated for convenience of description, and may be different from actual ratios.

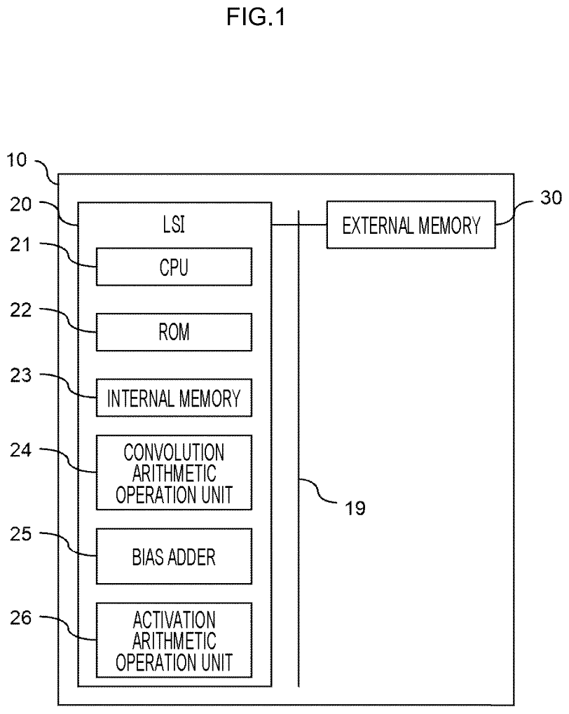

First, a hardware configuration of an inference processing device 10 according to the present embodiment will be described. As illustrated in FIG. 1, the inference processing device 10 includes an LSI 20 and an external memory 30. The components are communicably connected with each other via a bus 19.

The external memory 30 as a storage unit is an external memory of the LSI 20, and for example, DRAM is applied.

The LSI 20 includes a central processing unit (CPU) 21, read only memory (ROM) 22, an internal memory 23, a convolution arithmetic operation unit 24, a bias adder 25, and an activation arithmetic operation unit 26.

The CPU 21 is a central processing unit, executes various programs, and controls each unit. That is, the CPU 21 reads a program from the ROM 22 and executes the program using the internal memory 23 as a work area. The CPU 21 performs control of each of the above-described components and various types of arithmetic processing according to a program stored in the ROM 22. In the present embodiment, an inference processing program is stored in the ROM 22. The inference processing program may be one program or a program group including a plurality of programs or modules.

The ROM 22 stores various programs and various data. The internal memory 23 temporarily stores a program or data as a work area. For example, SRAM is applied as the internal memory 23.

The convolution arithmetic operation unit 24 is an arithmetic operation unit that executes convolution processing. The bias adder 25 is an adder that adds a bias to the convolution result. The activation arithmetic operation unit 26 is an arithmetic operation unit that applies an activation function to an input value.

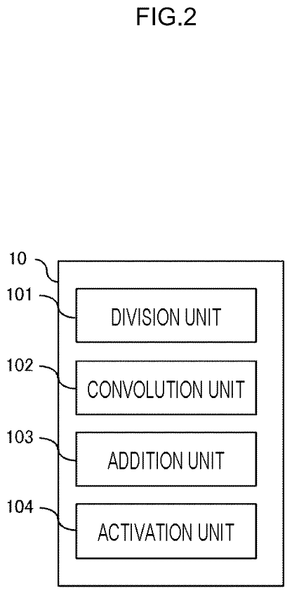

Next, a functional configuration of the inference processing device 10 will be described. As illustrated in FIG. 2, the inference processing device 10 includes a division unit 101, a convolution unit 102, an addition unit 103, and an activation unit 104. Each functional configuration is achieved by the CPU 21 reading the inference processing program stored in the ROM 22, loading the program onto the internal memory 23, and executing the program.

The division unit 101 divides the layer of the convolutional neural network into a plurality of sublayers in the channel direction. Specifically, the division unit 101 divides the layer stored in the external memory 30 into a plurality of sublayers in the channel direction. The division unit 101 divides the layer with the number of input channels in a range that can be stored in the internal memory 23 as one unit. For example, in a case where the capacity of the internal memory 23 is 4 MByte, a certain layer is a 3×3 kernel, 2048 input channels, and 1024 output channels, and the precision of the layer is 8 bits, since the kernel data is 18 MByte by 3*3*2048*1024*8 bits, the division unit 101 divides the layer into five or more sublayers according to 18/4. Then, since (4*8 bits*1024*1024)/(3*3*1024*8 bits) is 455, the division unit 101 suppresses the number of input channels per sublayer to 455 or less. Then, the division unit 101 delivers the divided one sublayer to the convolution unit 102.

The convolution unit 102 outputs a convolution result by executing the convolution processing for each sublayer delivered from the division unit 101. Specifically, the convolution unit 102 stores one sublayer read from the external memory 30 in the internal memory 23, and the convolution arithmetic operation unit 24 executes the convolution processing on the stored sublayers. Then, the convolution unit 102 delivers the convolution result (that is, the feature map that is an intermediate output output from the sublayer) to the addition unit 103.

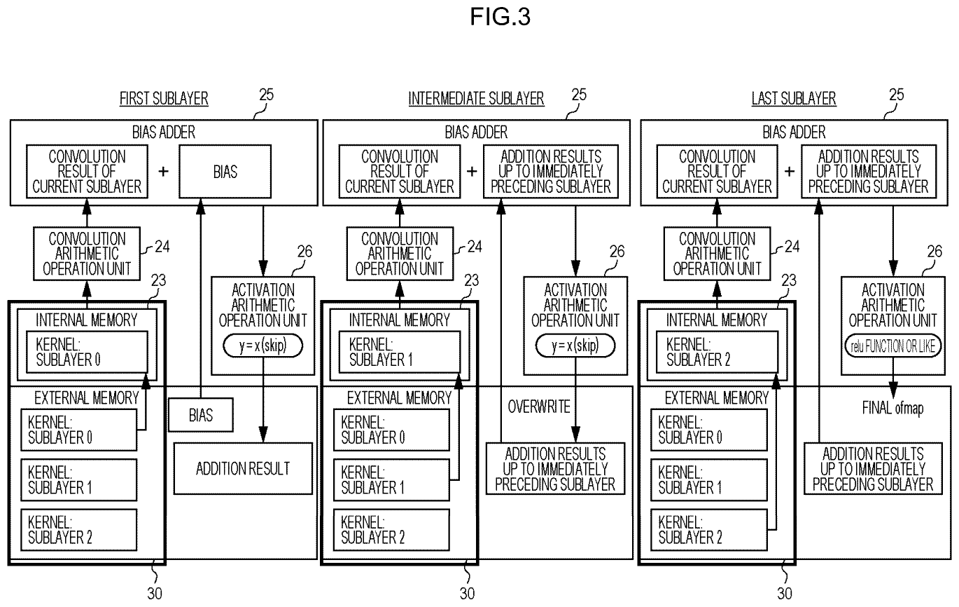

FIG. 3 illustrates a flow of convolution processing executed on each sublayer in a case where one layer is divided into three sublayers. Hereinafter, a sublayer on which first the convolution processing is executed is referred to as a first sublayer, a sublayer on which lastly the convolution processing is executed is referred to as a last sublayer, and a sublayer other than the first sublayer and the last sublayer is referred to as an intermediate sublayer.

As illustrated in FIG. 3, the convolution unit 102 reads sublayer 0 as the first sublayer from the external memory 30 and stores sublayer 0 in the internal memory 23. Then, the convolution unit 102 executes the convolution processing on sublayer 0 with the convolution arithmetic operation unit 24 and delivers the result to the bias adder 25. In addition, the convolution unit 102 reads sublayer 1 as the intermediate sublayer from the external memory 30 and stores sublayer 1 in the internal memory 23. Then, the convolution unit 102 executes the convolution processing on sublayer 1 with the convolution arithmetic operation unit 24 and delivers the result to the bias adder 25. In addition, the convolution unit 102 reads sublayer 2 as the last sublayer from the external memory 30 and stores sublayer 2 in the internal memory 23. Then, the convolution unit 102 executes the convolution processing on sublayer 2 with the convolution arithmetic operation unit 24 and delivers the result to the bias adder 25. Note that, in a case where the division unit 101 divides one layer into five sublayers, the number of the first sublayers is one, the number of the intermediate sublayers is three, and the number of the last sublayers is one.

Hereinafter, the sublayer read from the external memory 30 by the convolution unit 102 is referred to as a current sublayer. Then, a sublayer read from the external memory 30 by the convolution unit 102 immediately before the current sublayer is referred to as an immediately preceding sublayer.

The addition unit 103 adds an intermediate value obtained by cumulatively adding the convolution results up to the previous sublayer to the convolution result with the bias adder 25 every time the convolution unit 102 executes the convolution processing, thereby outputting the addition result. Specifically, when the convolution result of the first sublayer is delivered, the addition unit 103 adds the bias read from the external memory 30 to the convolution result of the first sublayer with the bias adder 25. Then, the addition unit 103 delivers the addition result of the convolution result of the first sublayer and the bias to the activation unit 104.

Then, after the convolution result of the second sublayer on which secondly the convolution processing has been executed is delivered, the addition unit 103 adds the convolution result of the current sublayer to the addition results up to the immediately preceding sublayer stored in the external memory 30. The addition results up to the immediately preceding sublayer are an intermediate value obtained by cumulatively adding the convolution results up to the previous sublayer as an addition result stored in the external memory 30 by the activation unit 104 to be described below. Then, the addition unit 103 delivers the addition result of the addition results up to the immediately preceding sublayer and the convolution result of the current sublayer to the activation unit 104. Specifically, the addition unit 103 sets the addition results up to the immediately preceding sublayer by overwriting the place where the bias is originally set in the bias adder 25. This is because it is sufficient that the bias can be added only once, and it is not necessary to add the bias for the second and subsequent sublayers as long as the bias can be added to the convolution result of the first sublayer. By performing addition for the sublayers with the existing bias adder 25, the convolution result can be obtained without adding a hardware resource.

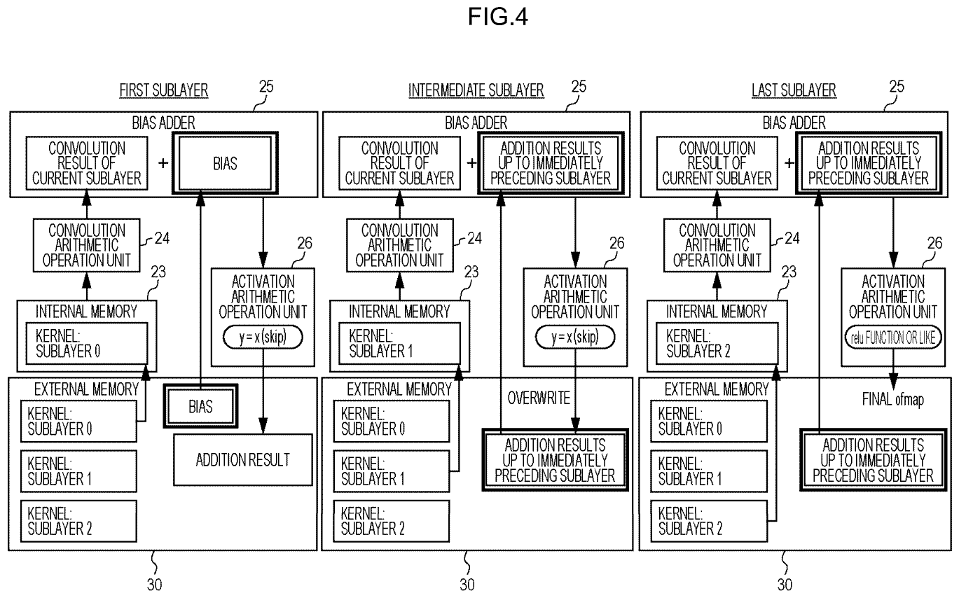

FIG. 4 illustrates a flow of processing of adding the convolution result with the bias adder 25. As illustrated in FIG. 4, the addition unit 103 adds the bias read from the external memory 30 to the convolution result of the first sublayer with the bias adder 25. Then, the addition unit 103 adds the addition results up to the immediately preceding sublayer read from the external memory 30 to the convolution result of the intermediate sublayer with the bias adder 25. In addition, the addition unit 103 also adds the addition results up to the immediately preceding sublayer read from the external memory 30 to the convolution result of the last sublayer with the bias adder 25.

When the addition result obtained by adding the convolution result of the last sublayer is delivered, the activation unit 104 inputs the addition result to an activation function (for example, relu function or the like) and stores the calculated feature map in the external memory 30. Hereinafter, the feature map output by the activation unit 104 is referred to as an output feature map (ofmap).

In addition, the activation unit 104 does not apply the activation function until the addition result obtained by adding the convolution result of the last sublayer is delivered from the addition unit 103, and inputs the delivered addition result to a linear function (Y=X) having a proportionality constant of 1 and an intercept of 0. As a result, the activation unit 104 does not substantially input the addition result to the activation function, and stores the addition result delivered from the addition unit 103 in the external memory 30 as it is.

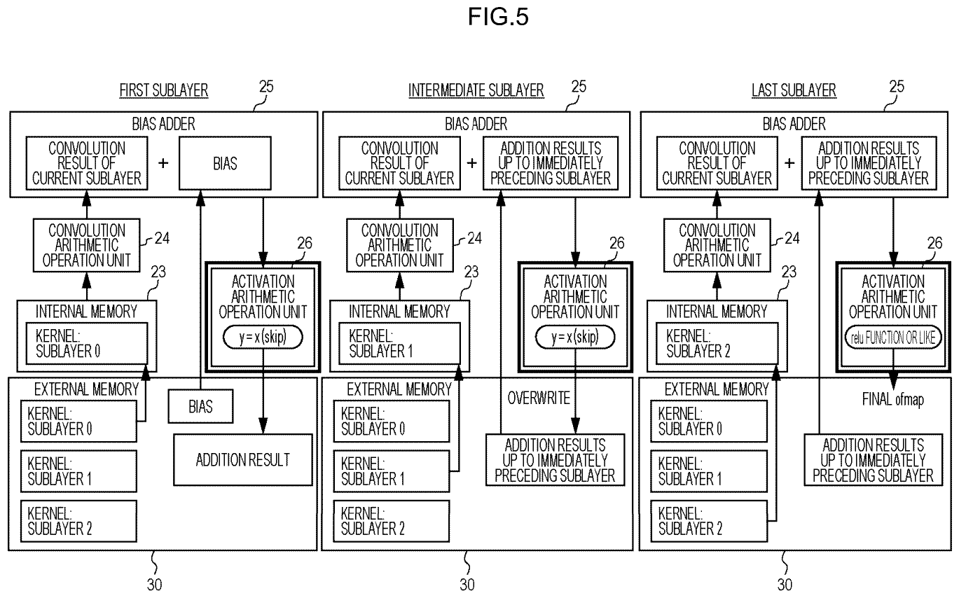

FIG. 5 illustrates a function for inputting an addition result. As illustrated in FIG. 5, the activation unit 104 inputs a value obtained by adding the convolution result of the first sublayer and the bias with the activation arithmetic operation unit 26 to a linear function having a proportionality constant of 1 and an intercept of 0, and stores the addition result in the external memory 30. Then, the activation unit 104 inputs a value obtained by adding the convolution result of the intermediate sublayer and the addition results up to the immediately preceding sublayer to the linear function with the activation arithmetic operation unit 26, and overwrites the addition result in the external memory 30. Then, the activation unit 104 inputs a value obtained by adding the convolution result of the last sublayer and the addition results up to the immediately preceding sublayer to the activation function with the activation arithmetic operation unit 26, and stores the calculated final output feature map in the external memory 30.

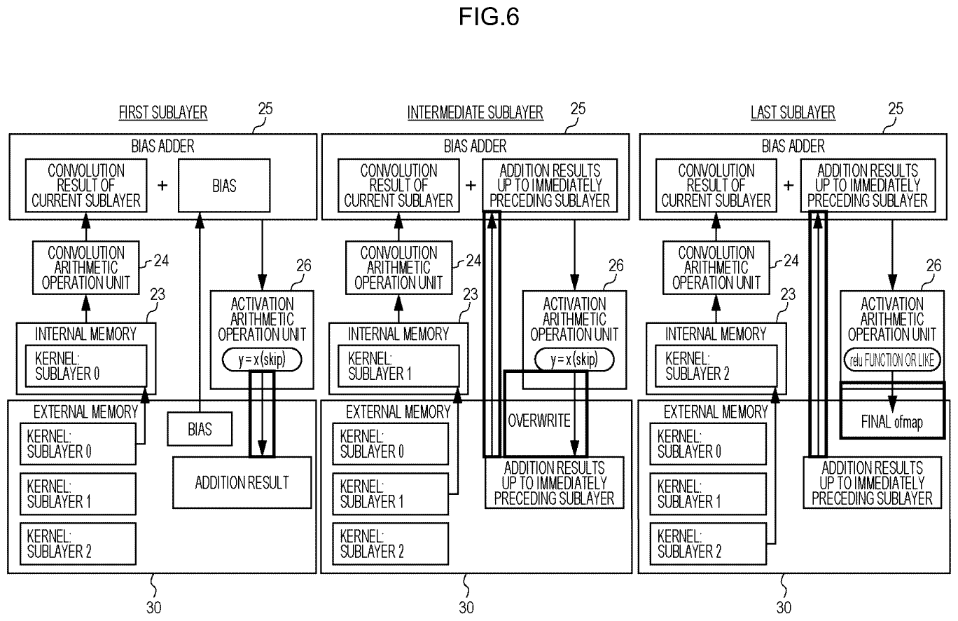

FIG. 6 illustrates a flow of processing of adding the addition result with the bias adder 25. As illustrated in FIG. 6, when the addition result obtained by adding the convolution result of the first sublayer or the addition result obtained by adding the convolution result of the intermediate sublayer is delivered, the activation unit 104 stores the addition result in the external memory 30 as it is. Then, the addition unit 103 adds the addition result read from the external memory 30 to the convolution result of the intermediate sublayer or the convolution result of the last sublayer with the bias adder 25. Then, the activation unit 104 inputs the addition result obtained by adding the convolution result of the last sublayer to the activation function, and stores the final output feature map in the external memory 30.

Next, the bit precision of each sublayer will be described.

In the present embodiment, until the convolution result of the last sublayer is input from the convolution unit 102, the addition unit 103 sets the bit precision of the addition result to be output to be higher than the bit precision of the value calculated by inputting the activation function to the addition result obtained by adding the convolution result of the last sublayer by the activation unit 104. Specifically, the addition unit 103 outputs the result with the bit precision as input from the convolution unit 102. In addition, until the addition result obtained by adding the convolution result of the last sublayer is input, the activation unit 104 sets the bit precision of the addition result stored in the external memory 30 to be higher than the bit precision of the value calculated by inputting the activation function to the addition result obtained by adding the convolution result of the last sublayer. Specifically, the activation unit 104 outputs the result with the bit precision as input from the addition unit 103. The activation unit 104 stores not the actual output feature map but the addition result input from the addition unit 103 in the external memory 30 until the addition result obtained by adding the convolution result of the last sublayer is input. This is because, when the bit precision of the output of the sublayer other than the last sublayer is made the same as the bit precision of the output of the last sublayer, the operational precision is lowered as compared with a case where the layer is not divided. As a result, it is not necessary to change the bit precision at the expense of the operational precision, and the data transferred to the external memory 30 can be reduced.

For example, in a case where the input feature map is 8 bits and the kernel data is 8 bits, performing multiplication as they are results in 16 bits, and therefore, the inference processing device 10 holds the intermediate result of the convolution processing at 16 bits or more instead of 8 bits. This is because when the inference processing device 10 reduces 16 bits to 8 bits every single convolution and then performs cumulative addition with 8 bits, the operational precision is greatly deteriorated. Then, after the cumulative addition is ended (or after addition of a bias or after input to an activation function in a further later stage), the inference processing device 10 reduces the intermediate result of the convolution processing to the bit precision of the output feature map. Specifically, in the above-described example, the inference processing device 10 reduces the intermediate result of the convolution processing from 16 bits to 8 bits.

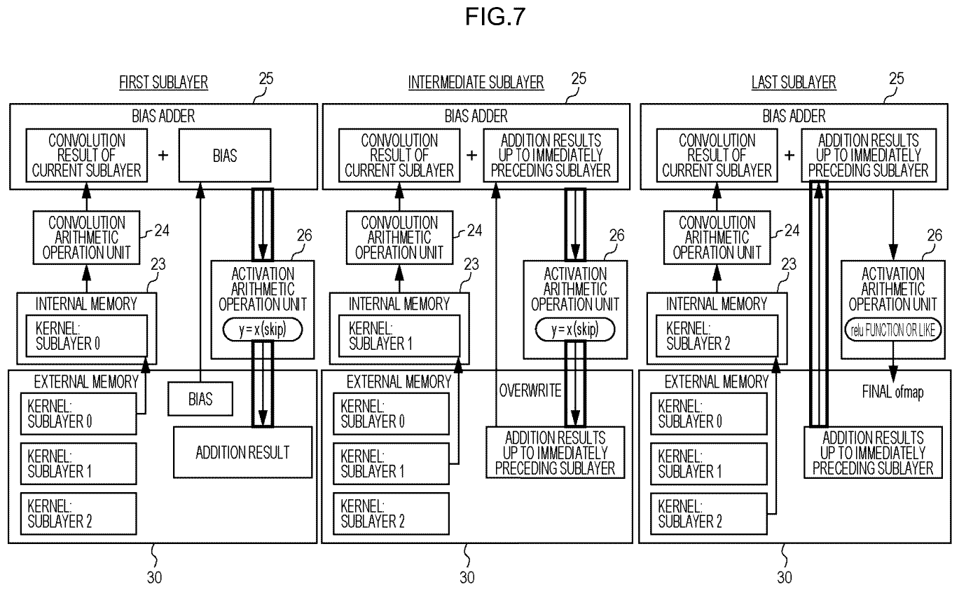

FIG. 7 illustrates a schematic diagram for describing bit precision. As illustrated in FIG. 7, the addition unit 103 delivers the addition result obtained by adding the convolution result of the first sublayer and the addition result obtained by adding the convolution result of the intermediate sublayer from the bias adder 25 to the activation arithmetic operation unit 26 with the bit precision as it is. Then, the activation unit 104 stores the addition result obtained by adding the convolution result of the first sublayer and the addition result obtained by adding the convolution result of the intermediate sublayer from the activation arithmetic operation unit 26 to the external memory 30 with the bit precision as it is. Then, the addition unit 103 adds, to the convolution result of the last sublayer, the addition result of the immediately preceding sublayer stored with the bit precision as it is by the activation unit 104.

Next, the setting set for each sublayer will be described.

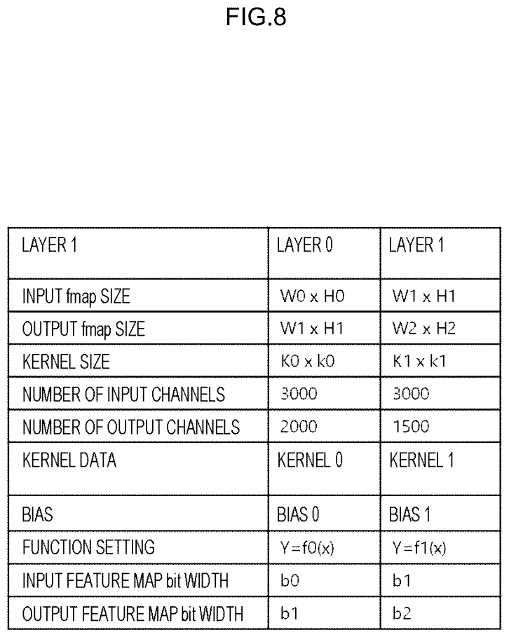

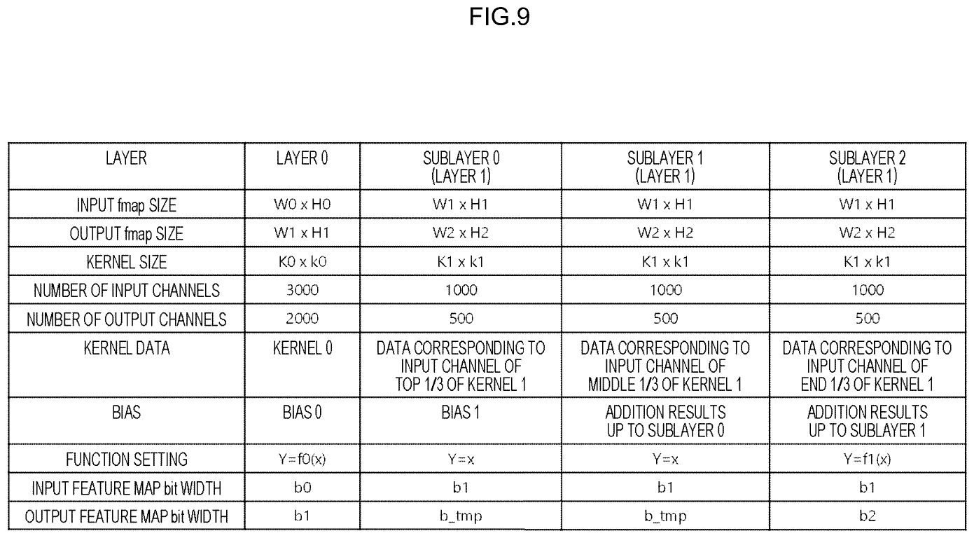

FIG. 8 illustrates an example of setting of layer 0 and layer 1, which are not divided. Then, FIG. 9 illustrates an example of the setting of layer 0 and sublayer 0, sublayer 1, and sublayer 2 obtained by dividing layer 1. Sublayer 0 is the first sublayer, sublayer 1 is the intermediate sublayer, and sublayer 2 is the last sublayer. As illustrated in FIG. 9, a function, a bias, and the like are set in each sublayer similarly to the undivided layer. Accordingly, the hardware for a CNN can generally process the sublayers as one layer. As a result, it is possible to perform convolution processing that can be generally supported while suppressing an increase in hardware resources and processing time.

As for the number of input channels, as illustrated in FIG. 8, in a case where 3000 input channels are set in layer 1 before the division, as illustrated in FIG. 9, 1000 input channels are set in each of sublayer 0, sublayer 1, and sublayer 2. Note that, in the example illustrated in FIG. 9, the input channel is equally divided into three, but it is not limited to this example. The number of input channels of one sublayer may not be equally divided as long as it is a data size that can be stored in the internal memory 23.

As for the kernel data, as illustrated in FIG. 8, in a case where kernel 1 is set in layer 1 before the division, as illustrated in FIG. 9, for sublayer 0, data corresponding to the input channel of the top ⅓ of kernel 1 is set, for sublayer 1, data corresponding to the input channel of the middle ⅓ of kernel 1 is set, and for sublayer 2, data corresponding to the input channel of the end ⅓ of kernel 1 is set.

As for the bias, as illustrated in FIG. 8, in a case where bias 1 is set in layer 1 before the division, as illustrated in FIG. 9, bias 1, which is an actual bias, is set for sublayer 0, addition results up to sublayer 0 are set for sublayer 1, and addition results up to sublayer 1 are set for sublayer 2. Note that, as the practical setting for the inference processing device 10, it is sufficient that an address of corresponding data on the external memory 30 is designated as the read address. As the function set for the activation arithmetic operation unit 26, as illustrated in FIG. 8, in a case where Y=fl(x) as an activation function is set in layer 1 before the division, a linear function of Y=X is set for sublayer 0 and sublayer 1, and Y=fl(x) as an activation function is set for sublayer 2, as illustrated in FIG. 9.

As for the bit precision of the output feature map, as illustrated in FIG. 8, when b2 is set in layer 1 before the division, as illustrated in FIG. 9, b2 is also set in sublayer 2. Then, b_tmp is set in sublayer 0 and sublayer 1. b_tmp is set not to the original precision of the output feature map but to the precision during the convolution processing in order to suppress the deterioration of the operational precision.

Next, an operation of the inference processing device 10 according to the present embodiment will be described.

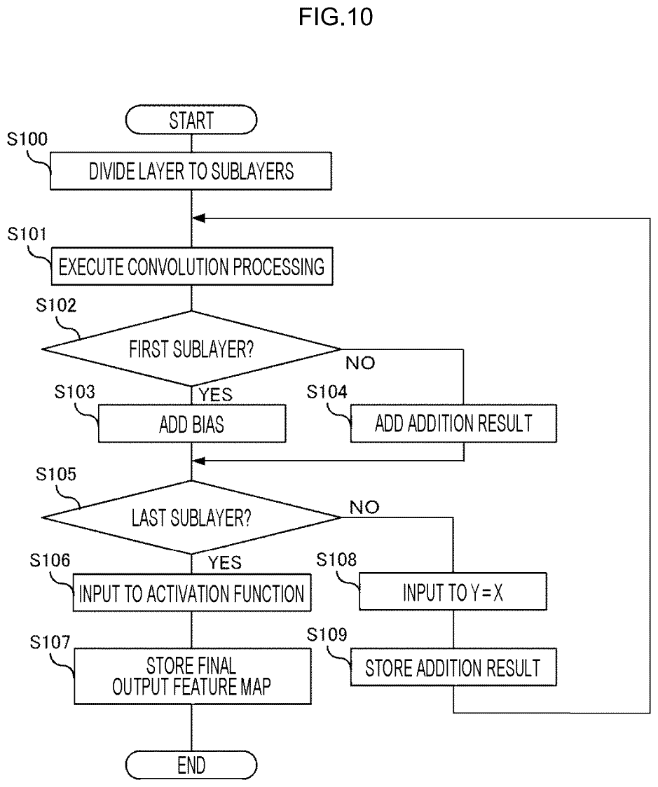

FIG. 10 is a flowchart illustrating a flow of inference processing by the inference processing device 10. The CPU 21 reads the inference processing program from the ROM 22, loads the inference processing program onto the internal memory 23 and executes the inference processing program, thereby performing the inference processing.

In step S100, as the division unit 101, the CPU 21 divides the layer into a plurality of sublayers in the channel direction.

In step S101, as the convolution unit 102, the CPU 21 outputs the convolution result by executing the convolution processing on one sublayer delivered.

In step S102, as the addition unit 103, the CPU 21 determines whether or not the output convolution result is the convolution result of the first sublayer. If the output convolution result is the first sublayer (step S102: YES), the CPU 21 proceeds to step S103. On the other hand, if the output convolution result is not the first sublayer (step S102: NO), the CPU 21 proceeds to step S104.

In step S103, as the addition unit 103, the CPU 21 adds the bias to the output convolution result of the first sublayer.

In step S104, as the addition unit 103, the CPU 21 adds the addition result to the output convolution result of the sublayer other than the first sublayer.

In step S105, as the activation unit 104, the CPU 21 determines whether or not the output addition result is an addition result obtained by adding the convolution result of the last sublayer. If the output addition result is an addition result obtained by adding the convolution result of the last sublayer (step S105: YES), the CPU 21 proceeds to step S106. On the other hand, if the output addition result is not an addition result obtained by adding the convolution result of the last sublayer (step S105: NO), the CPU 21 proceeds to step S108.

In step S106, as the activation unit 104, the CPU 21 inputs an addition result obtained by adding the convolution result of the last sublayer to the activation function.

In step S107, as the activation unit 104, the CPU 21 stores the final output feature map in the external memory 30 and ends this inference processing.

In step S108, as the activation unit 104, the CPU 21 inputs the delivered addition result to a linear function having a proportionality constant of 1 and an intercept of 0.

In step S109, as the activation unit 104, the CPU 21 stores the addition result in the external memory 30, and returns to step S101.

Next, an effect of the inference processing device 10 according to the present embodiment will be described.

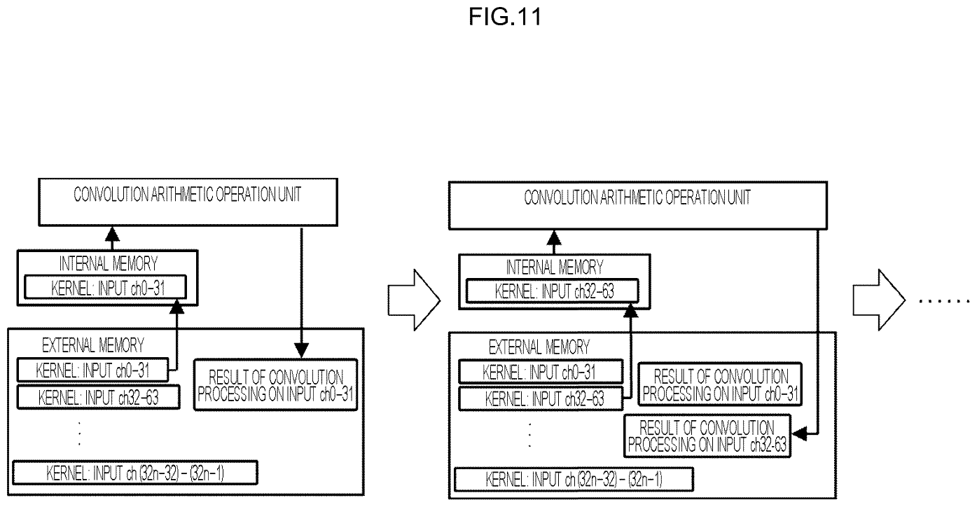

FIG. 11 illustrates processing executed in the conventional art when data for 32 channels can be stored in the internal memory. As illustrated in FIG. 11, in the conventional art, kernel data is divided into 32 channels in each input channel, sequentially reads into the internal memory, and the convolution processing is executed. Then, the convolution result is stored in the external memory. In this case, it is necessary to read the 32 convolution results stored in the external memory into the hardware and finally integrate the 32 convolution results. Accordingly, it is necessary to add an adder circuit for integrating the convolution results into the hardware. In addition, in order to obtain a final output feature map, it is also necessary to apply the activation function to the convolution result obtained by adding all the input channels. Further, there is a possibility that the processing time increases.

With respect to this problem, the inference processing device 10 according to the present embodiment divides a layer into a plurality of sublayers and calculates a final operational result using an existing arithmetic operation circuit, so that it is possible to perform the convolution processing that can be generally supported while suppressing an increase in hardware resources and processing time.

### Modification

Note that the present disclosure is not limited to the above-described embodiment, and various modifications and applications can be made without departing from the gist of this disclosure.

In addition, various types of processing executed by the CPU reading and executing software (program) in the above embodiment may be executed by various processors other than the CPU. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing a specific process, such as an application specific integrated circuit (ASIC). In addition, the inference processing may be executed by one of these various processors, or may be executed by a combination of two or more processors of the same type or different types (for example, a plurality of FPGAs, a combination of a CPU and an FPGA, or the like). In addition, a hardware structure of these various processors is, more specifically, an electric circuit in which circuit elements such as semiconductor elements are combined.

In addition, in the above embodiment, the aspect in which the inference program is stored (installed) in advance in the ROM 22 has been described, but it is not limited thereto. The program may be provided in the form of being stored in a non-transitory storage medium such as a compact disk read only memory (CD-ROM), a digital versatile disk read only memory (DVD-ROM), or a universal serial bus (USB) memory. In addition, the program may be downloaded from an external device via a network.

Regarding the above embodiment, the following supplements are further disclosed.

### Supplementary Note 1

An inference device including:
a memory; and
at least one processor connected to the memory,
in which
the processor
divides a layer of a convolutional neural network into a plurality of sublayers in a channel direction;
executes convolution processing for each of the sublayers to output a convolution result;
adds an intermediate value obtained by cumulatively adding convolution results up to a previous sublayer to the convolution result with an adder for adding a bias to the convolution result every time the convolution processing is executed, and outputs an addition result; and
inputs, to an activation function, the addition result obtained by adding the convolution result of a last sublayer on which the convolution processing has been executed last.

### Supplementary Note 2

A non-transitory storage medium storing a program executable by a computer to execute inference processing,
in which
the inference processing
divides a layer of a convolutional neural network into a plurality of sublayers in a channel direction;
executes convolution processing for each of the sublayers to output a convolution result;
adds an intermediate value obtained by cumulatively adding convolution results up to a previous sublayer to the convolution result with an adder for adding a bias to the convolution result every time the convolution processing is executed, and outputs an addition result; and
inputs, to an activation function, the addition result obtained by adding the convolution result of a last sublayer on which the convolution processing has been executed last.

### REFERENCE SIGNS LIST

10 Inference processing device
19 Bus
20 LSI
21 CPU
22 ROM
23 Internal memory
24 Convolution arithmetic operation unit
25 Bias adder
26 Activation arithmetic operation unit
30 External memory
101 Division unit
102 Convolution unit
103 Addition unit
104 Activation unit

1. An inference processing device comprising:
a memory; and
at least one processor coupled to the memory, the at least one processor being configured to:
divide a layer of a convolutional neural network into a plurality of sublayers in a channel direction;
execute convolution processing for each of the sublayers to output a convolution result;
add an intermediate value obtained by cumulatively adding convolution results up to a previous sublayer to the convolution result with an adder for adding a bias to the convolution result every time the convolution processing is executed, and outputs an addition result; and
input, to an activation function, the addition result obtained by adding the convolution result of a last sublayer on which the convolution processing has been executed last.

2. The inference processing device according to claim 1, wherein the at least one processor does not apply the activation function until the addition result obtained by adding the convolution result of the last sublayer is input, and stores the input addition result in the memory as it is.

3. The inference processing device according to claim 2, wherein the at least one processor adds the bias to the convolution result with the adder for a first sublayer on which the convolution processing has been executed first, and adds the addition result read from the memory to the convolution result with the adder after the convolution result of a second sublayer on which the convolution processing has been executed second is input.

4. The inference processing device according to claim 2, wherein the at least one processor inputs the input addition result to a linear function having a proportionality constant of 1 and an intercept of 0 until the addition result obtained by adding the convolution result of the last sublayer is input.

5. The inference processing device according to claim 1, wherein, until the convolution result of the last sublayer is input the at least one processor sets bit precision of the addition result to be output to be higher than bit precision of a value calculated by inputting the activation function to the addition result obtained by adding the convolution result of the last sublayer.

6. The inference processing device according to claim 2, wherein, until the addition result obtained by adding the convolution result of the last sublayer is input, the at least one processor sets bit precision of the addition result to be stored in the memory to be higher than bit precision of a value calculated by inputting the activation function to the addition result obtained by adding the convolution result of the last sublayer.

7. An inference processing method comprising causing a computer to execute processing comprising:
dividing a layer of a convolutional neural network into a plurality of sublayers in a channel direction;
executing convolution processing for each of the sublayers to output a convolution result;
adding an intermediate value obtained by cumulatively adding convolution results up to a previous sublayer to the convolution result with an adder for adding a bias to the convolution result every time the convolution processing is executed, and outputting an addition result; and
inputting to an activation function, the addition result obtained by adding the convolution result of a last sublayer on which the convolution processing has been executed last.

8. A non-transitory computer-readable storage medium storing an inference processing program for causing a computer to function as the inference processing device according to claim 1.
